(19) United States
(12) Patent Application Publication
(10) Pub. No.: US 2024/0319001 A1
(43) Pub. Date: Sep. 26, 2024

(54) ELECTRONIC FISH SCALE

(71) Applicant: AOB Products Company, Columbia, MO (US)

(72) Inventors: Kyle Martin, Columbia, MO (US); Kyle Mauzey, Columbia, MO (US); Michael Boeding, Columbia, MO (US); Dennis W. Cauley, Fayette, MO (US); Timothy S. Kinney, Warrenton, MO (US); Matthew Kinamore, Columbia, MO (US); James Tayon, Moberly, MO (US)

(73) Assignee: AOB Products Company, Columbia, MO (US)

(21) Appl. No.: 18/616,161

(22) Filed: Mar. 25, 2024

Related U.S. Application Data
(60) Provisional application No. 63/492,065, filed on Mar. 24, 2023.

(51) Int. Cl. G01G 19/18; G01C 9/06; G01G 17/00; G01G 19/20; G01G 23/01; G01G 23/36

(52) U.S. Cl. CPC G01G 19/18; G01C 9/06; G01G 17/00; G01G 19/20; G01G 23/01; G01G 23/36

(57) ABSTRACT

An electronic fish scale, associated systems, components thereof, and associated methods. An electronic scale holdable by a hand of a user is configured to determine a weight of a fish. The scale can include an accelerometer that facilitates weighing of the fish. Multiple scales can be networked to provide a tournament fishing scale system.

### CROSS-REFERENCE TO RELATED APPLICATION

The present application claims priority to U.S. Provisional Patent App. No. 63/492,065, filed Mar. 24, 2023, which is hereby incorporated by reference in its entirety for all purposes.

### FIELD

The present disclosure generally relates to weighing scales, and more particularly to electronic handheld weighing scales.

### BACKGROUND

Handheld weighing scales are commonly used to measure the weight of a fish. A relatively large fish may weigh upwards of sixty pounds.

### SUMMARY

In one aspect, an electronic fish scale comprises a housing and a load cell supported by the housing. The load cell is configured to generate load cell data responsive to a fish supported by the load cell. A user interface is supported by the housing. An accelerometer supported by the housing is configured to generate accelerometer data. A fish scale controller is configured to receive the motion data. The fish scale controller is operable to determine a weight of the fish supported by the load cell. A non-transitory tangible storage medium coupled to the fish scale controller stores fish scale controller executable instructions configured to, when executed by the fish scale controller, determine the weight of the fish supported by the load cell as a function of the load cell data and the accelerometer data.

In another aspect, an electronic fish scale comprises a housing. A load cell supported by the housing is configured to generate load cell data responsive to a fish supported by the load cell. A user interface supported by the housing includes a display. An orientation sensor supported by the housing is configured to generate orientation data associated with the load cell. A fish scale controller is configured to receive the orientation data. The fish scale controller is operable to determine a weight of the fish supported by the load cell. A non-transitory tangible storage medium coupled to the fish scale controller stores fish scale controller executable instructions configured to, when executed by the fish scale controller, implement an orientation guide on the display to guide a user to properly orient the load cell for correct orientation of the load cell to correctly generate load cell data with the load cell.

Other objects and features of the present disclosure will be in part apparent and in part pointed out herein.

### BRIEF DESCRIPTION OF THE DRAWINGS

FIG. 1 is a right perspective of an electronic fish scale;

FIG. 2 is a left perspective of a right housing portion;

FIG. 3 is a left perspective of the right housing showing a battery compartment door in an open position;

FIG. 4 is a perspective of a lithium battery pack;

FIG. 5 is a perspective of a battery tray;

FIG. 6 is a perspective of the electronic fish scale and the battery tray holding batteries;

FIG. 7 is an enlarged fragmentary right perspective of the electronic fish scale;

FIG. 8 is a top view of the electronic fish scale;

FIG. 9 is a block diagram of a control system of the electronic fish scale;

FIG. 10 is a left elevation of a second embodiment of an electronic fish scale;

FIG. 11 is an enlarged fragmentary right perspective of a load cell assembly of the second embodiment;

FIG. 12 is an enlarged rear elevation of the load cell assembly of the second embodiment;

FIG. 13 is a bottom view of the electronic fish scale of the second embodiment;

FIG. 14 is another embodiment of the control system of the present disclosure;

FIG. 15 is a perspective of another embodiment of a fish scale of the present disclosure;

FIG. 16 is a top perspective of a user interface of the fish scale of FIG. 15;

FIG. 17 is a schematic of a control system of the fish scale;

FIG. 18 is a perspective of a culling system useable with the fish scale;

FIG. 19 is a perspective of a culling tag of the culling system;

FIG. 20 is a screenshot of a display of the fish scale in a Tournament mode;

FIG. 21 is a screenshot of a display of the fish scale in a Rally mode;

FIG. 22 is a screenshot of a display of the fish scale in a Competition mode;

FIG. 23 is a top view of the fish scale showing the display in Tournament mode and showing a digital bubble level to assist the user in correctly orienting the scale to take a weight measurement;

FIG. 24 is a schematic of a smart device useable with the fish scale;

FIG. 25 is a screenshot of a Home view of an app run by the smart device;

FIG. 26 is a screenshot of a Logbooks Trips view of the app;

FIG. 27 is a screenshot of a Logbooks Catches view of the app;

FIG. 28 is a screenshot of a Map view of the app;

FIG. 29 is a screenshot of a Map Bounds view of the app for defining boundaries for a tournament;

FIG. 30 is a screenshot of a Create Tournament view of the app for setting up a tournament;

FIG. 31 is a schematic of a fishing scale system of the present disclosure;

FIG. 32 is a schematic of another fishing scale system of the present disclosure;

FIG. 33 is a schematic of another fishing scale system of the present disclosure;

FIGS. 34-38 show example topologies for communicating data from the scale or scales to a remote server or external scoring system;

FIG. 39 is a schematic of a “heads up display” of a fish scale system of the present disclosure; and

FIG. 40 is a schematic of another embodiment of a fish scale of the present disclosure including a communications expansion bay.

Corresponding reference numbers indicate corresponding parts throughout the drawings.

### DETAILED DESCRIPTION

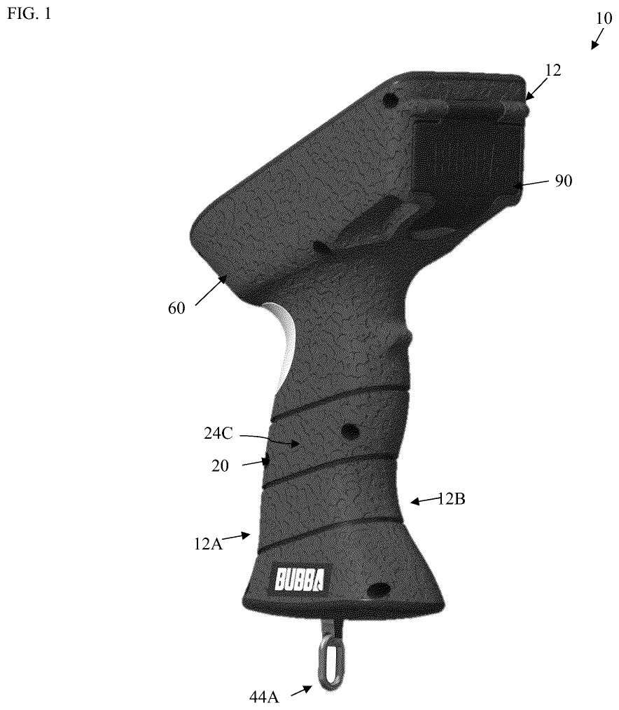

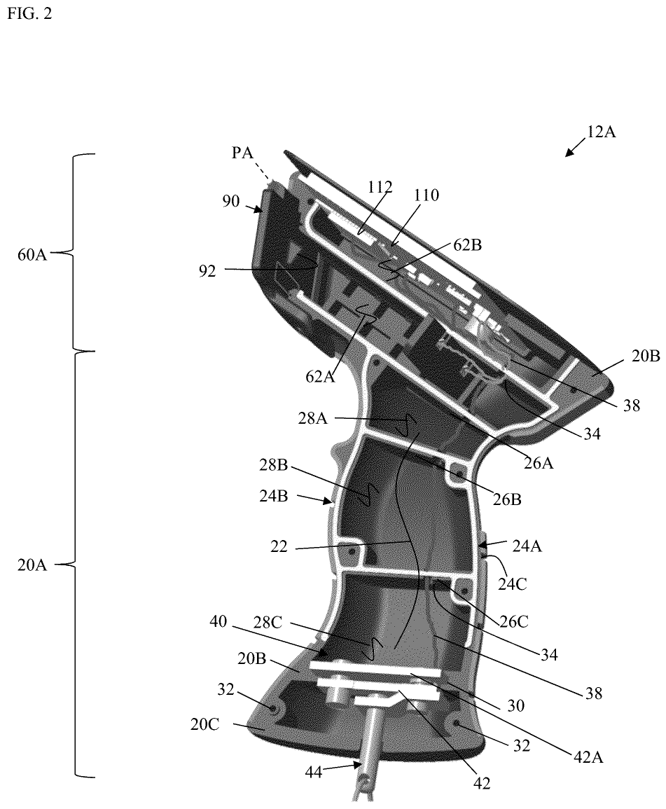

Referring to FIGS. 1 and 2, a first embodiment of an electronic fish scale of the present disclosure is generally indicated by 10. The electronic fish scale can be used to measure the weight of a fish (broadly, object) up to about sixty pounds or more.

A housing 12 of the electronic fish scale 10 comprises a handle 20 and a head 60 supported by the handle. The housing 12 houses internal electronic components such as a load cell (sensor) assembly 40 and a battery 80 (broadly, power source). The housing 12 is sized and shaped to be grasped by either one or both hands of a user (fisherperson) while the fish is suspended below the handle via a connector 44A. As will be explained in greater detail below, the head is configured to contact a top part of the fisherperson's index finger and thumb (broadly, hand) while weighing the fish. Such contact assists the fisherperson in handling the weight of the fish suspended below the electronic fish scale.

In use, the internal electrical components may communicate useful data to the fisherperson via a user interface. For example, the data may include the weight of the fish, the bag weight of all the fish they have caught during an outing, where a specific fish ranks in comparison to the other fish caught in the outing (broadly, culling), global positioning system (GPS) location of where the fish was caught, etc.

The handle defines an interior cavity 22 and the head defines a compartment 62. The interior cavity 22 is sized and shaped to house the load cell assembly 40. The compartment comprises a battery compartment 62A sized and shaped to house the battery 80, and an electrical compartment sized and shaped to house various internal electronic components.

In the illustrated embodiment, the housing includes right (first) and left (second) housing portions 12A, 12B. The right and left housing portions have complementary features that, when connected, define the interior cavity 22 and the compartment 62

Referring to FIG. 2, the right housing portion 12A will be described in greater detail with the understanding the left housing portion 12B is substantially similar but a mirror image. Accordingly, with respect to the right and left housing portions “right” and “left” indicators for respective “right” and “left” features will generally be omitted.

A part of the housing portion that defines part of the interior cavity 22 of the handle 20 can generally be referred to as a handle housing 20A. The handle housing 20A is sized and shaped to house and support the load cell assembly 40 (broadly, weight sensor), as will be explained in more detail herein. The handle housing includes a rear side, a front side opposite the rear side, left and right sides therebetween, and a top portion and a bottom portion below the top portion. The handle housing includes a housing body 20B comprising a rear side wall 24A, a front side wall 24B opposite the rear side wall, and a side wall 24C connecting the rear and front side walls. The walls share a common interior surface. The housing body includes ribs 26A, 26B, 26C which extend between the walls. The housing body defines mounts 30 (broadly, load cell connection structure), as will be described in greater detail below. The housing body has an end portion 20C (facing out of the page, as shown in FIG. 2). The end portion defines openings 32 for receiving fasteners for connecting the right and left housing portions. In the illustrated embodiment, the housing body is formed from injection molded plastic, but any suitable material can be used.

As shown in FIG. 2, the rear and front side walls 24A, 24B extend generally into the page while the side wall 24C extends generally therebetween. The rear side wall has a curved profile different than the front side wall, as will be explained in greater detail below. Each interior surface of the rear and front side walls smoothly transitions into the side wall 24C. In the illustrated embodiment, first, second, and third ribs 26A, 26B, 26C are spaced apart between the rear, front, and side walls to define first, second, and third chambers 28A, 28B, 28C of the handle housing. The ribs define receivers 34 for receiving wiring 38. The ribs may provide structural support to the handle.

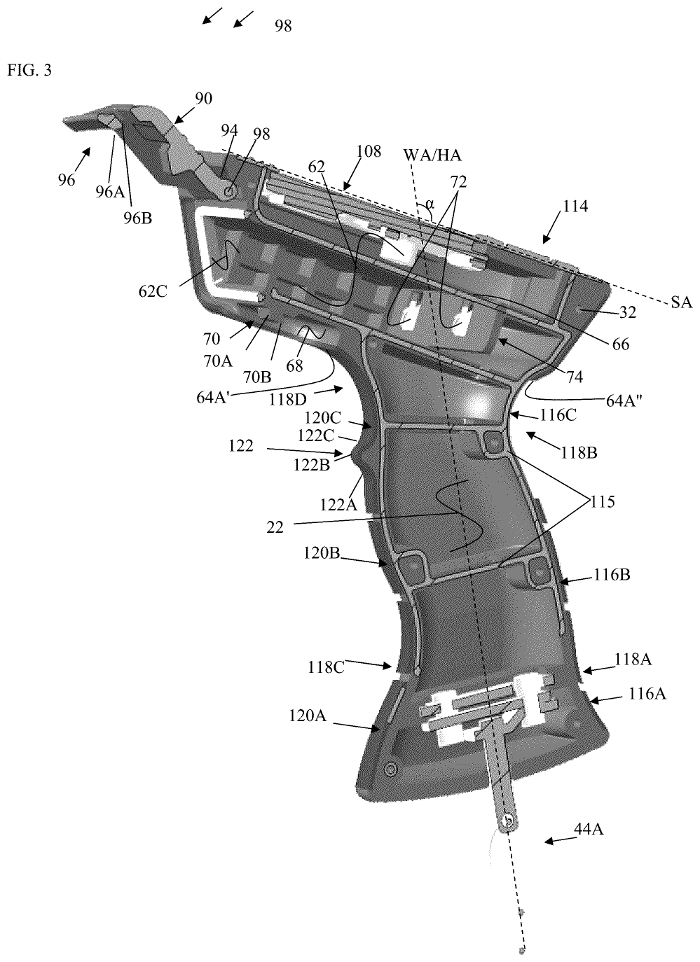

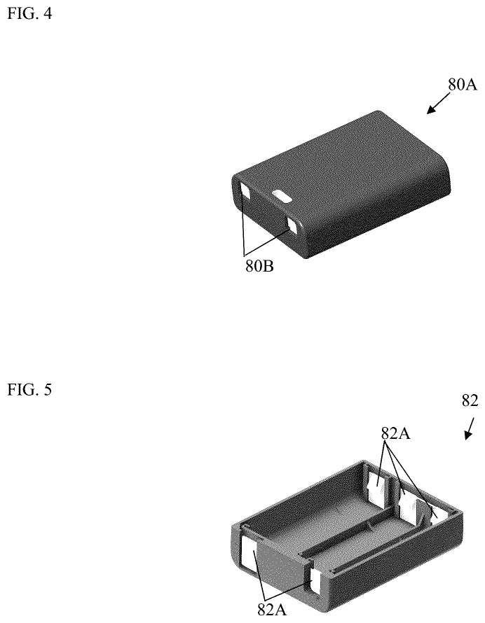

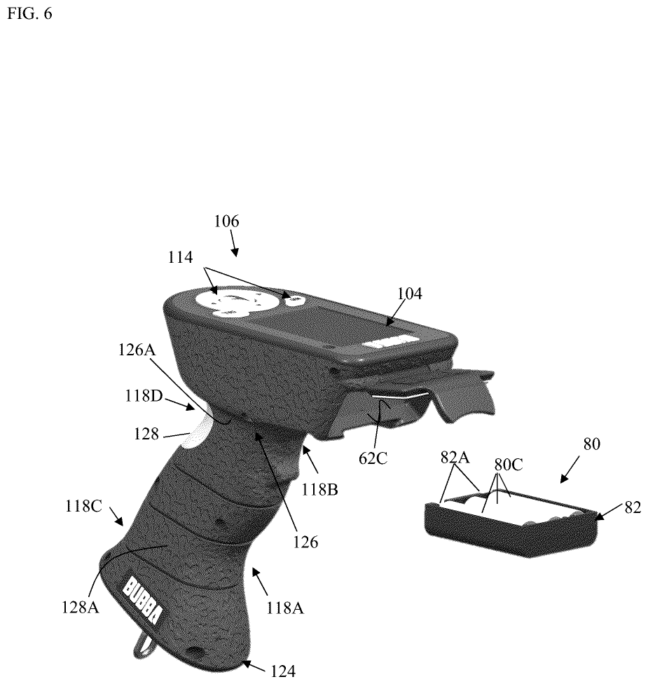

The mounts 30 include support members protruding inward from the interior walls. In the illustrated embodiment, a pair of mounts 30 protruding from opposite sides of the interior walls are configured to support the load cell assembly. The load cell assembly 40 includes a load cell (sensor), a mounting bracket 42A (broadly, housing body connection structure), and a connector body 44. The mounting bracket includes a plate which defines openings for receiving fasteners (e.g. bolts) for connecting the plate to the mounts. The load cell is operatively supported below the plate and includes a strain gauge. The connector body 44 includes a proximal end operatively connected to the load cell and a distal end opposite the proximal end. The distal end of the connector body includes an opening configured to receive a ring 44A (broadly, connector). The connector body 44 defines a longitudinal weighing axis WA (FIG. 3) extending through the connector body and the handle housing.

The load cell assembly is mounted below the head 60 and below the upper end of the handle 20. In the illustrated embodiment, the mounts 30 are located in the third chamber 28C. Each mount comprises a slot sized and shaped for receiving a respective side of the mounting plate. Each slot includes holes for aligning with the holes of the mount. Fasteners (e.g. bolts) can be used for fastening the mounting plate to the slot. The distal end of the connector body 44 protrudes downward through an opening defined by the bottom portion of the handle.

Referring to FIG. 3, a part of the housing 12 that defines part of the compartment 62 can generally be referred to as a head housing 60A. The head housing 60A is sized and shaped to house the battery and other electrical components. The head housing 60A has a rearward portion and a forward portion opposite the rearward portion. The head housing includes the housing body 20B comprising a bottom wall 64A, top wall 64B, a rear wall 64C, and side walls 64D extending forward from the rear wall. The walls share a common interior surface. The top wall defines an opening. The housing body includes an intermediate wall 66 (broadly, compartment partition wall) for separating the battery compartment 62A from the electronic compartment 62A. In the illustrated embodiment, distal ends of the walls define a mouth 62C of the battery compartment. The bottom wall has a bottom face 64A′ which faces generally downward. A portion of the bottom face 64A′ comprises an abutment surface indicated by 64A″. The abutment surface 64A″ is configured to receive the Purlicue (broadly, web of hand) of the fisherperson's hand. The Purlicue is that space on a person's hand between the index finger and thumb. The bottom wall comprises a finger recess 68 and a retainer 70 (broadly, cover connection structure). In the illustrated embodiment, the retainer includes a lip 70A having a barb 70B. The housing body defines openings 32 for receiving fasteners to connect the housing portions.

In the illustrated embodiment, the battery compartment 62A is sized to house the length and width of three AA batteries. The battery compartment 62A includes electrical contacts 72 for operatively engaging with the batteries 80. In the illustrated embodiment, a panel 74 supports the electrical contacts 72. The panel is mounted to the intermediate wall 66. In the illustrated embodiment, the panel defines part of the battery compartment 62A. The electrical compartment houses part of a control system 100 comprising a controller 102 (e.g., printed circuit board), the power source 80, user interface 106, a display screen 108, a tangible storage medium 112 (TSM), and wiring 38 (broadly, circuitry). The user interface comprises a user input 106A which includes the display screen 108 and buttons 114 (broadly, actuators). The display screen is viewable through the opening defined by the top wall of head. In the illustrated embodiment, the display screen 108 lies in a screen plane SA. The screen plane SA intersects the weighing axis WA at a skew angle a. Desirably, the angle is greater than 90 degrees. Such an angle tilts the screen toward the user's line of sight. The buttons 114 are located near a periphery of the top side of the head such that the user may press the buttons with a thumb of the hand grasping the handle.

The control system of the electronic scale can store weights detected by the load cell assembly. The display can show the weight in real time being detected by the load cell assembly. The control system can have a “Bag Weight” mode or feature were the display shows the total weight of all the weights (or a subset thereof such as all the weights from that day) stored in the control systems memory (e.g., a total weight of all the fish weighed). For example, the total weight can represent the weight of all the fish currently held in a live well. The control system can have a “Cull” mode or feature where the display indicates which weight in the memory is the least so that when a user has exceeded a bag limit and catches a heavier fish, the display identifies which fish the user should release. The control system can have a “Rally” mode or feature where the control system compares the weight of the newest weighed fish to all the weights in the memory, so that the user knows whether the newest fish is the heaviest or where it ranks among the other recorded weights. It will be appreciated that the tangible storage medium 112 stores instructions executable by the controller 102, and is responsive to the user input 106A and the load cell 40, to carry out these functions and modes.

Each battery includes positive and negative electrical contacts on opposite ends thereof. In the illustrated embodiment, the batteries include a lithium battery pack 80A having electrical contacts 80B. Alternatively, the scale may be powered by three AA batteries indicated generally by 80C. A tray 82 (battery holder) is configured to hold the three AA batteries. Interior end surfaces of the tray include electrical contracts 82A for engaging with the batteries held therein. In the illustrated embodiment, one exterior end of the tray includes electrical contact ports for operatively engaging with the electrical contacts of the battery compartment 62A.

Wiring 38 operatively connects the load cell assembly 40 to the battery 80 and controller 102. The receivers 34 defined by the ribs and intermediate wall permit the wiring to be routed through housing body.

Referring to FIGS. 2 and 3, a compartment door 90 (broadly, cover) is sized and shaped to cover the area of the mouth 62C. The compartment door 90 includes an interior, exterior surfaces, and upper and lower side portions. The upper side portion includes a pivot arm 94 (broadly, head connection structure). The pivot arm defines an opening configured to receive a pin 98. The lower side of the door includes a keeper 96 (broadly, head connection structure) configured to engage with the retainer 70 of the head. The keeper 96 includes a latch 96A for engaging with the barb 70B of the retainer 70. The pivot arm of the door is configured to align with the pivot arms of the head. The pin 98 feeds through the pivot arms and defines a pivot axis PA. The pivot axis permits the door to move between open and closed positions. In the illustrated embodiment, a pusher member 92 protrudes from the interior surface of the cover. Other door connections (e.g. living hinge) are possible without departing from the scope of this disclosure.

In the closed position, the keeper of the door is engaged with the retainer of the head. It will be appreciated the keeper/retainer engagement is located on the bottom face 64A′ of the head. In the illustrated embodiment, the pusher member 92 of the door pushes the battery into operative engagement with the electrical contacts of the battery compartment, depending on the power source being used. If the power source is the tray 82, the pusher member will push on a wall of the tray holding the batteries, causing the opposite wall to engage the electrical contacts of the battery compartment. If the power source is the lithium battery pack 80A, the pusher member will push on an outside side of the pack, causing the opposite side to engage the electrical contacts of the battery compartment. Such operative engagement closes the electrical circuit and supplies power to the control system. In the open position, the keeper disengages from the retainer. The disengagement causes the pusher member to break contact from the battery, causing the battery to disengage from the electrical contact of the battery compartment which opens the circuit. Other configurations can be used without departing from the scope of the present disclosure.

The configuration of the keeper/retainer arrangement is such that the user may open and close the door by latching and/or unlatching the keeper from the retainer with one hand without the use of any tools. Specifically, the user inserts a fingertip into the finger recess 68 to unlatch the keeper. It will be appreciated that the keeper/retainer arrangement is enclosed by the finger recess to prevent the keeper from inadvertently unlatching from the retainer.

The housing portions are waterproofed prior to being connected. An epoxy (broadly, sealant) is applied to the interior surfaces and connection joints. A gasket 115 (broadly, sealing material) may be installed over the connection joints. FIGS. 2 and 3 illustrate the gasket bounding the electrical compartment, the battery compartment, the first and second chambers, and most of the third chamber. FIG. 2 illustrates the gasket raised slightly above the end portion 20C to ensure the seal is watertight and there is no gapping when the housing portions are connected. A waterproof wiring harness and/or sealant (e.g., epoxy) may be installed in the grooves defined by the ribs to ensure the wires do not contact water or moisture.

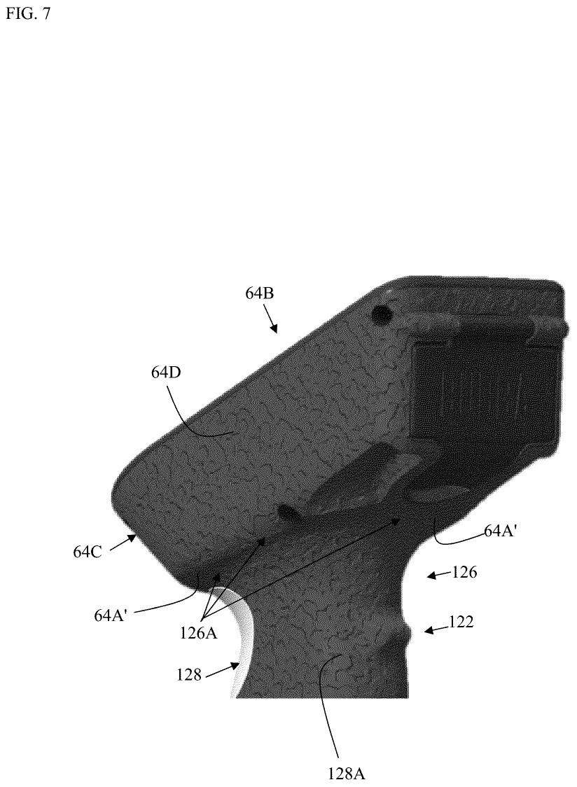

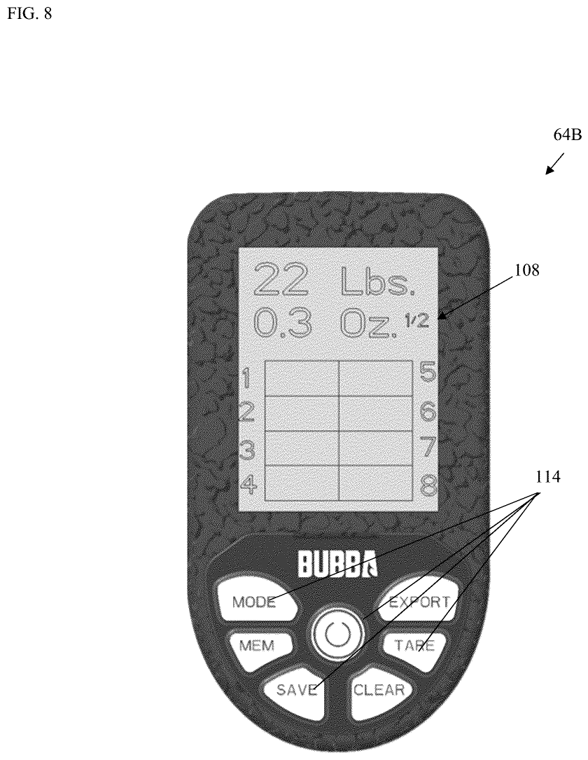

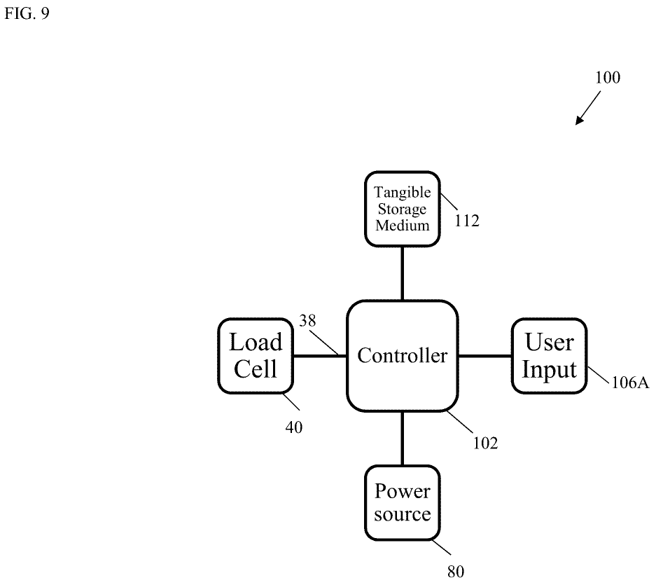

In view of the above, it is understood the electronic scale is formed more generally when the left and right housing portions are connected. Referring to FIG. 7, the top portion of the handle transitions into the bottom wall 64A′ of the head. The bottom side of the head extends outwardly from the top portion of the handle. The configuration is such that the handle is bounded by a projection of the perimeter of the head, or the handle lies in a footprint of the head.

An ergonomic shape of the handle assists the fisherperson while weighing a fish. The configuration is such that the fisherperson may grasp the handle with either their left or right hand, or both left and right hands together. A handle axis HA (FIG. 3) extends through the handle and coincides with the weighing axis WA, generally indicated by WA/HA. In the illustrated embodiment, the handle is configured to resemble a grip (e.g., pistol grip) of a handheld firearm (e.g. a pistol, revolver, etc.). Referring to FIG. 3, the rear side of the handle comprises three curving segments 116A, 116B, 116C which together form a slight concave surface of the rear side of the handle. The first segment 116A curves slightly inwardly before smoothly transitioning back slightly outwardly into transition with the second segment. The transition of the first and second segments forms a first indentation 118A. The second segment 116B slopes generally upwardly but slowly slopes outwardly and back inwardly until it transitions into the third segment 116C. The third segment has a more pronounced curve rearwardly where it transitions into the bottom face of the head. The transition of the third segment to the bottom face of the head forms a second indentation 118B. The front side of the handle, comprises three curving sections 120A, 120B, 120C. The first section 120A slopes inwardly and upwardly (more upwardly than the first segment of the rear side of the handle), before transitioning into the second section 120B. The transition of the first and second sections forms a third indentation 118C. The second section slopes slightly outwardly and slightly back inwardly until it transitions to a rib 122. The rib includes a first jog 122A forward, a peak 122B, and a second jog rearward 122C. The second jog transitions to the third section. The third section is generally upright then has a more pronounced forward curve transitioning to the bottom face of the head. The transition from the third section to the bottom face of the head forms a fourth indentation 118D. The slopes of the first segment 116A and first section 120A together form a foot 124 at a base portion of the handle. The slopes and the transitions (broadly, curvatures) that make up the indentations provide smooth transition surfaces that that are sized and shaped to correspond with the ergonomics of the user's hand when the user is grasping the handle. “Smooth transition surfaces,” generally means surfaces that gradually change course and do not form abrupt angles. For example, such abrupt changes in course may create an undesirable pinch-point or pressure-point on the user's hand. The configuration is such that the curvatures provide a comfortable grip. Modification to the ergonomics of the handle are not outside the scope of this disclosure.

Referring to FIG. 7, a neck 126 of the handle is formed by the second and fourth indentations 118B, 118D. A shoulder 126A is formed by transition of the upper parts of the second and fourth indentations into the bottom face 64A′ of the head. The rib 122 may assist the user in locating the shoulder 126A. A gripping pad 128 may be installed over the neck of the rear side of the handle for added comfort when grasping the handle. The gripping portion is overmolded with a thermoplastic elastomer gripping material 128A (e.g. Kraton) to further assist the user when grasping the handle. The handle and head configuration combined with the gripping material improves the fisherperson's control of the handle while weighing a heavy object (e.g. a fish).

In use, the fisherman connects the connector hook to the fish, or vice versa. Grasping the handle, the user suspends the fish from the scale. The strain gauge transmits an electrical signal to the controller 102 via the wiring 38. The tangible storage medium stores a value representative of the weight of the fish. The display shows a value representative of the weight of the fish.

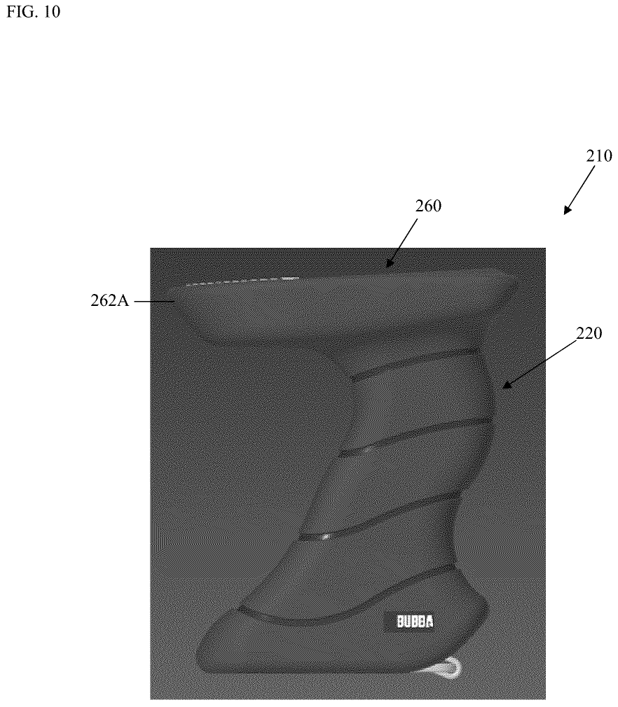

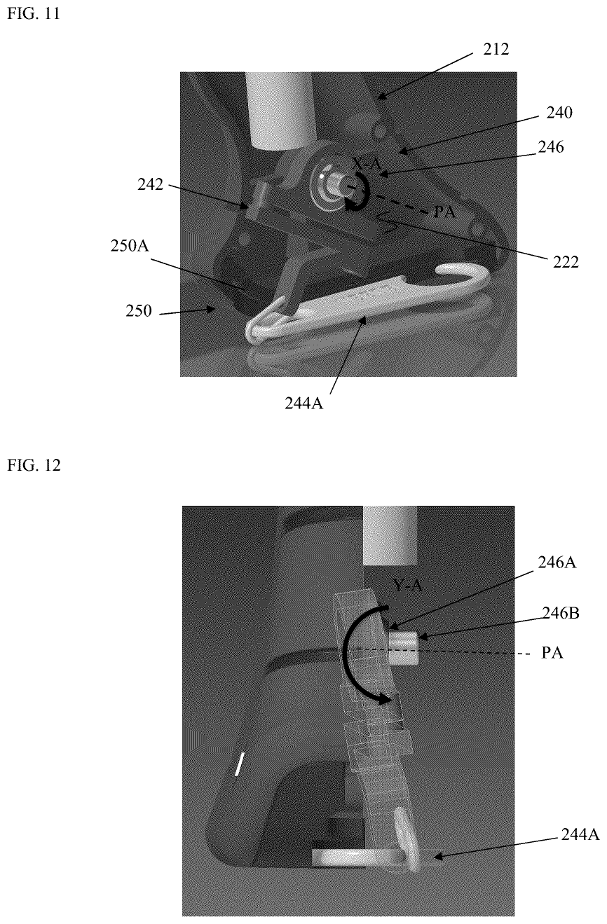

Referring to FIGS. 10-13, the electronic scale 210 is similar to the electronic scale 10 and the like components are indicated by like reference numbers, plus 200. For example, the electronic scale 210 includes a housing 212, a handle 220, a head 260 supported by the handle, a battery compartment 262A to house a battery, and a load cell assembly 240 housed by an interior cavity 222 of the handle. In this embodiment, a swivel connection 246 connects the load cell assembly to the body of the handle. The swivel may include a single axis (e.g., x-axis), indicated X-A, or a multi-axis (e.g. x-axis and y-axis), indicated Y-A, swivel, that allows the load cell assembly to pivot relative to the housing. As illustrated by FIGS. 11-12, the swivel includes a swivel bearing 246A that rotates about a pin supported by the housing. The pin defines a pin axis PA about which the bearing moves. The swivel bearing allows rotation about the x-axis and the y-axis. The swivel connection enables the load cell to articulate or pivot due to the relative position of the housing and the object being weighed to promote a perpendicular status to the direction of pull against the load cell. For example, a user's hand may unintentionally move, rotate, and/or shake as the object is being weighed by the scale. The swivel ensures the force applied by the object is generally perpendicular to the load to ensure an accurate measurement by the load cell.

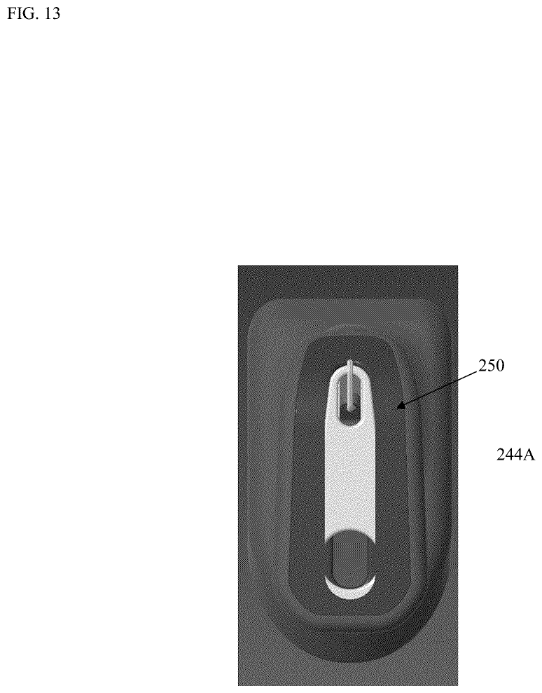

Referring to FIGS. 13, the connector includes a hook 244A connected to the load cell assembly. A base portion of the handle housing comprises a receiver 250 configured to permit the scale to rest upright in a standing position on a support surface, such as a table. To allow this to happen, the hook is captured and stowed in the base portion of the handle. In the illustrated embodiment, the receiver includes a resiliently deformable sleeve 250A (e.g. resiliently compressible) flexible polymer component. The swivel allows the hook to rotate and be tucked into the sleeve. Other configurations (e.g. friction fit, snap fit, etc.) maybe used to enable the foot of the handle to stand freely on a support surface without interference from the hook.

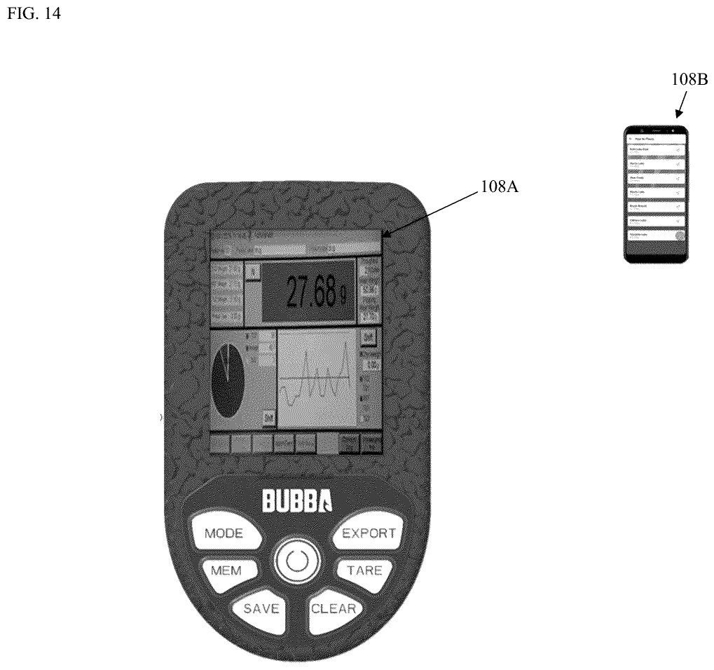

Referring to FIG. 14, in another embodiment, the user interface of the electronic scale may comprise a liquid-crystal display (LCD) screen 108A. The control system of the electronic scale may also include wireless connectivity (e.g., wifi, Bluetooth, etc.) to connect with a mobile device or smart device such as a cell phone, tablet or computer, generally indicated as 108B. For example, the electronic scale can be connected to a cell phone so that the information (e.g., weights) from the electronic scale can be viewed on the cell phone using an app. The scale may include a location sensor (e.g., GPS sensor) for logging location of a weight measurement representing location of where a fish was caught and weighed. This information can be transmitted wirelessly (e.g., via Bluetooth) to the smart device. The electronic scale may also have an internal rechargeable battery and an electrical port (e.g., USB port) for charging the rechargeable battery.

It will be appreciated that the electronic scale permits fisherpeople to measure and record statistical data about the fish they catch. For example, such information can include the weight of the fish, the bag weight of all the fish they have caught during an outing, where a specific fish ranks in comparison to the other fish caught in the outing, global positioning system (GPS) location of where the fish was caught, etc.

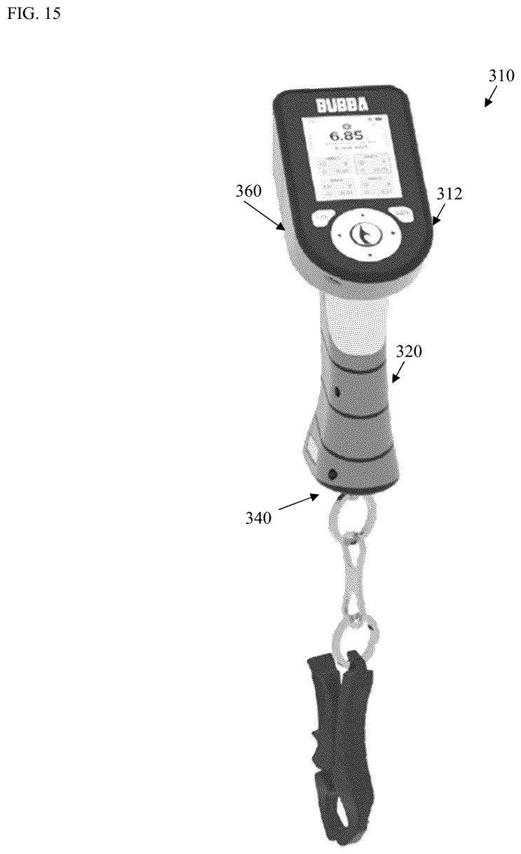

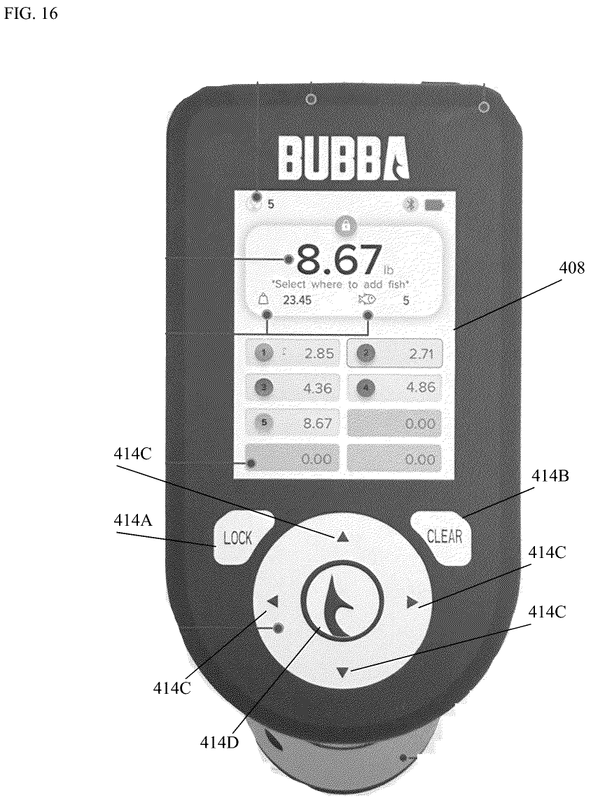

Referring to FIGS. 15 and 16, another embodiment of an electronic scale is indicated generally by the reference number 310. The scale is similar to the scale 10, and like components are indicated by like reference numbers, plus 300. For example, the electronic scale includes a housing 312, a handle 320, a head 360, and a load cell assembly 340. The scale 310 may have essentially the same construction as the scale 10 except to the extent differences are noted hereafter. The scale 310 is useable with a smart device such as the smart device 108B described above with respect to FIG. 14.

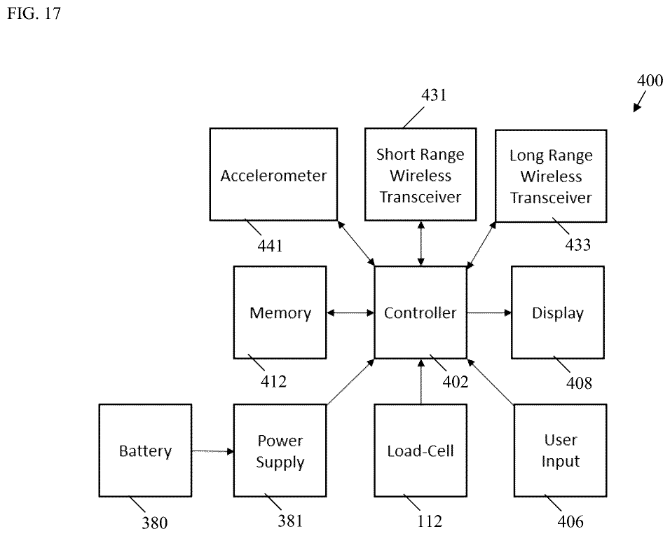

Referring to FIG. 17, the scale 310 includes control system 400 comprising a controller 402 (e.g., processor), a power source 380 (e.g., lithium battery pack or tray with AA cells), power supply 381 (e.g., regulates the “dual fuel” input), user interface including a user input 406A and a display screen 408, a tangible storage medium 412 (TSM), and interconnections electronics (e.g., wiring or other circuitry and/or wireless communication devices) connecting the various components. The user input 406A can include buttons (broadly, actuators). In some embodiments, the display may be a touch screen and thus comprise at least part of the user input. The controller 402 reads load cell data, receives input from the user input 406A, signals outputs to the display 408, recalls data from memory 412, and sends and receives wireless data via the wireless transceiver(s) 431, 433. The load cell 340 precisely measures the weight suspended from the handle (e.g., from clip 313), and provides weight information via signals to the controller 402. The user input 406A includes various buttons including a Lock button 414A, Clear button 414B, Navigation buttons 414C, and a Select button 414D. The user input may include a microphone 415. The display 408 (e.g., LCD or OLED) conveys information to a user, such as weight information. An accelerometer 441 (broadly, motion sensor or orientation sensor) inside the housing of the scale 310 is configured to sense motion of the scale, such as vibration, jarring, waving, etc. and to generate corresponding motion data (e.g., accelerometer data). The tangible storage medium 412 stores non-volatile settings, weight and bag information, stores instructions executable by the controller 402, and is responsive to the user input 406A and the load cell 340, to carry out functions, modes, and features disclosed herein. The scale 310 may include on or more wireless transceivers 431, 433. For example, the scale may include a short range wireless transceiver 431 (e.g., Bluetooth, WiFi, or the like) for connectivity to a corresponding smart device 108B and a long range wireless transceiver 433 (e.g., cellular network, satellite network, GPS, or the like) for connecting to a remote server (e.g., cloud server).

To use the scale, a user can turn on the scale 310 by pressing the Select button 414D. If the weight is non-zero, user tares the scale by pressing Clear button 414B. The user attaches a fish to the weighing end of the scale using a clip 341 or other connector. The user holds the scale 310 steadily so that the stem 344 of the load cell (extending along axis WA/HA (FIG. 3)) is vertical. The ergonomics of the scale 310 make it so that the scale is naturally supported by the user's hand to promote the correct orientation. When the weight stabilizes, the auto-lock function will lock the weight on the scale. If auto-lock is disabled or has not occurred yet, then the Lock button 414A can be pressed to instantly lock the scale. At this point, the weight of a fish is locked in the scale 310 and the user can make a decision to clear the weight (to re-weigh or discard the weight) by pressing the Clear button 414B or to use the weight in any of the functional modes: Tournament, Competition, Rally, described in more detail below.

FIG. 16 shows an example view (graphic interface) that may be displayed on the display 408. The view includes near the top a weight measurement section indicating a current weight 521 (e.g., weight of a fish) carried by the scale. The weight measurement section is common to the various modes of the scale. When a fish is supported by the scale 310, the displayed weight will fluctuate until it is “locked” and then available to be stored. The view in FIG. 16 shows the current weight locked at 8.67 pounds.

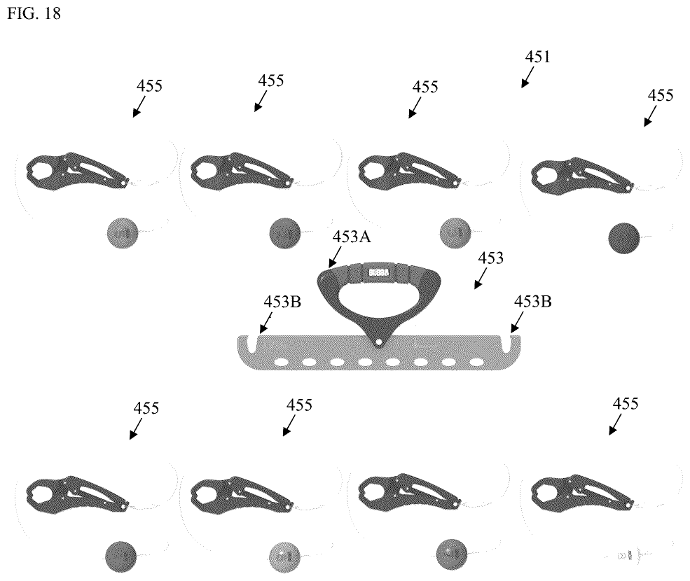

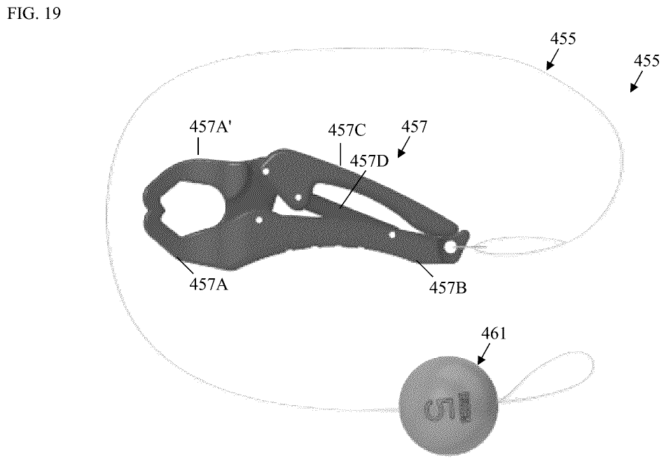

Referring to FIGS. 18 and 19, a culling system is indicated generally by the reference number 451. The culling system includes a balance 453 and a plurality of tags 455. The tags 455 are configured to be connected to a fish kept in a live well or other reservoir. The tags each include a connector 457, a tether 459 and a float 461. In the illustrated embodiment, the connector 457 comprises a clip comprising first and second jaws 457A, 457A′ and first and second levers 457B, 457C. The jaws are applied to a mouth of a fish, and the levers are brought together to clamp the jaws on the fish. A linkage 457D connecting the second lever 457C to the first lever 457B permits the second lever to move “over center” with respect to the first lever as the second lever is moved toward the closed position. In the closed position, the distal ends of the first and second levers 457B, 457C are adjacent each other, and the levers extend toward each other as they extend from intermediate portions of the levers toward the distal ends. The distal end of the first lever 457B defines a recess in which the distal end of the second lever 457C is received in the closed configuration. The floats 461 (e.g., foam balls) are configured to float in water, such as in a live well. The floats 461 are unique relative to each other in that they have different colors, different numbers, or other unique identifying indicia to facilitate a user in identifying a fish to be culled. The balance 453 comprises a handle 453A and a beam 453B pivotably connected to the handle. The beam includes hangers 453C at opposite ends thereof to hang tags 455 thereon such that two tagged fish can be weighed against either other to determine the lighter fish and thus the fish to cull. Culling systems having other configurations can be used without departing from the scope of the present disclosure. For example, a stringer may be provided with color coded clips (e.g., tags) to uniquely identify each clip to work with the smart cull system.

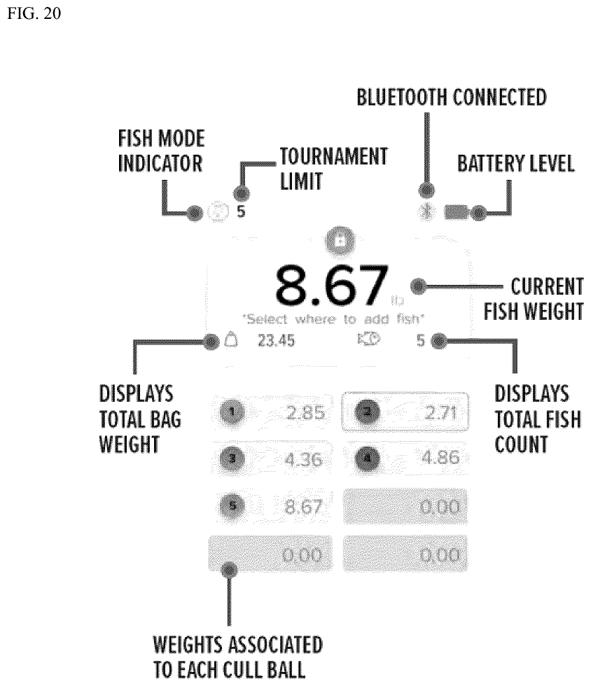

FIG. 20 shows an example view of the display when the scale 310 is in a Tournament mode. In the Tournament mode, below the weight measurement section, a culling section is provided. The culling section includes an array (e.g., two rows) of cull tag displays representing respective cull tags of the culling system. The status of the respective cull tags may be shown by status indicators such as symbols, color, outlining, bolding, flashing, text, numbers, graphics, or other indicators. In the illustrated embodiment, the cull tag displays that have a dim or gray appearance are inactive. In the Tournament mode, the user can set a bag limit (maximum number of fish) for the “bag” causing unused cull tag displays to be inactive. The cull tag displays that are active are indicated at least by a cull tag identification indicator (e.g., a number or color unique to that cull tag). Among the active cull tag displays, those associated with cull tags currently on a fish in the live well include a non-zero weight indicator (e.g., weight number, such as 2.85 lb). When a new fish is weighed and the weight is locked, the user will add the fish to the “bag” by navigating (e.g., via Navigation buttons 414C) to a culling indicator (colored and numbered circle) and pressing the Select button 414D. If there is an unused active cull tag display (e.g., indicated by a weight of 0.00), the user would typically choose that cull tag display to receive the locked weight and connect the corresponding cull tag to the fish. The user will attach a cull tag to the fish with a matching color or number or both and put the fish in the live well. Upon catching the maximum number of fish, the user will “cull” any additional fish, making a determination if the new fish is bigger than the smallest fish in the bag. If the new fish is smaller, then it will be thrown back and the user presses Clear button 414B to clear the weight. If the new fish is bigger than the smallest fish, then the user will use the buttons to clear the smallest fish (and throw it back) and move the cull indicator to the new larger fish.

The smart culling system strives to minimize the time an angler spends culling fish, so they can focus on catching more fish. The user or tournament specifies the limit for the tournament (e.g., 1-8 fish) so that smart cull can make suggestions on where to add fish and help prevent common errors like accidentally replacing a fish or catching more than the limit. When the bag is not yet “full” (e.g., maximum number of fish has not yet been reached) the smart cull system will automatically highlight (e.g., outline in green, or another color (broadly, display a “suggested location” indicator)) the tag display with respect to the next unused cull indicator (e.g., the next number in a sequence of 1-5) so the fish can rapidly be added to the filled display. If the user desires to use that indicated unused tag display, the user merely needs to press the Select button 414D. In essence, the user interface automatically navigates to the suggested tag display to permit the user to enter the fish with as few actions as possible. However, the user can choose to replace at fish or use a different tag display by navigating (buttons 414C) away from the tag display that smart cull selected and then pressing Select button 414D. When the bag is full, the smart cull system will automatically select the tag display of the smallest fish in the bag (if the system decides the weight of the current fish is larger than the weight of the smallest fish already weighed) so that the smallest fish can more rapidly be replaced without requiring the user to manually locate and navigate to it. After the weight of the larger fish is locked, the tag display for the lightest fish is highlighted (e.g., outlined in green, or another color (broadly, “suggested location” indicator), so the user merely needs to press the Select button 414D to replace the lighter fish with the new heavier fish (and move the corresponding cull tag to the new fish). In essence, the user interface automatically navigates to the suggested tag display to permit the user to enter the fish with as few actions as possible. If desired, the user can navigate away from the suggested tag display to enter the new fish in a different tag display. It will be appreciated that the smart cull system provides efficiency and reduces error potential in the user implementing a culling process. Colored feedback and arrows can indicate to the user before any fish is added to the bag if the result is a net increase in weight or a decrease in weight.

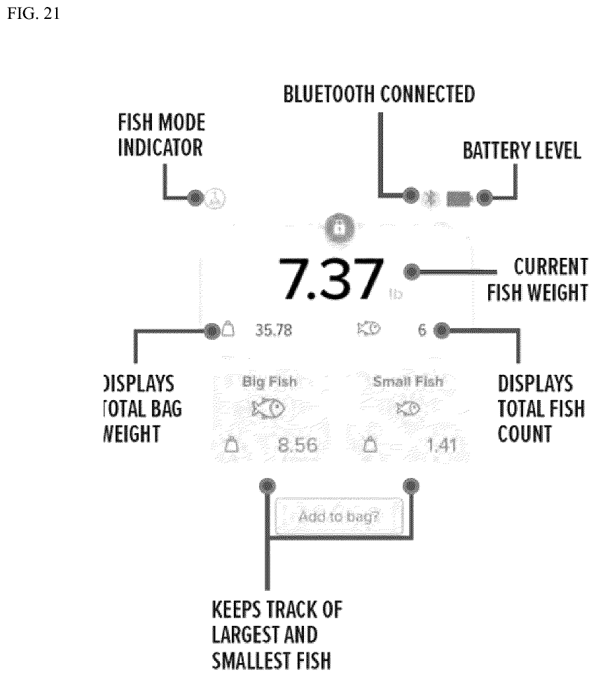

Rally mode will now be discussed with reference to FIG. 21. In Rally mode, the cull indicators are not used. Rally mode allows the user to keep count of total fish caught, total bag weight, biggest fish, and smallest fish. In Rally mode, the display shows, below the weighing section, a rally section including a Big Fish display and a Small Fish Display. As the user catches and weighs fish, the scale automatically updates the Big Fish and Small Fish displays to indicate the heaviest and lightest of the fish caught. Moreover, a total bag weight (total weight of all fish caught) is shown in in the weighing section below the current weight. When a user weighs a fish, they can choose to add the fish to the bag and update all the values. This data is stored indefinitely, so the user can use this to track their statistic for any duration of time (day, season, lifetime). Data can be cleared in the menu settings.

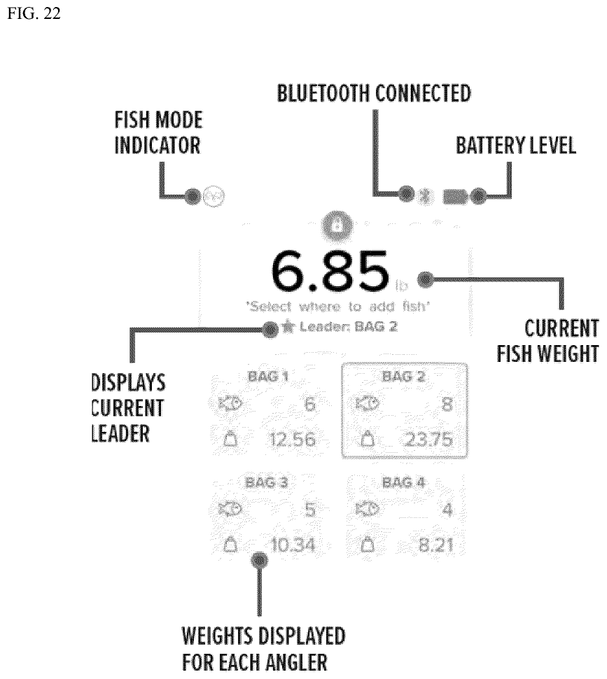

Competition mode will be discussed with reference to FIG. 22. In Competition mode, multiple users (selectable from 2 to 4), such as users in the same boat, can participate on the same scale. The mode is similar rally mode in that each competitor has a bag or competitor display showing a total number of fish and a total bag weight. When a fish is weighed, the user must select which numbered bag (1-4) the fish will be added to. Users compete to see who has the highest bag weight. The leader is shown on the display at all time. Optionally, each bag or competitor display could show heaviest fish for each bag. This mode could be expanded to include other competition features and more statistics such as: biggest fish, tournament catch limit, culling, etc.

Professional tournament fishers prioritize time fishing and want to minimize time weighing fish, managing their live well, or interacting with equipment. The smart fish scale is designed to minimize interaction time in Tournament mode to help the angler fish more. The software is designed to start up very rapidly with different power modes so the scale is available to weigh faster, without draining batteries and requiring time to replace them. The auto-shutdown feature causes the scale to shut down automatically after a preset amount of time. The user does not have to turn off the scale manually. The scale is configured to start up quickly such that it enters the weighing screen and is ready to measure a weight of a new fish immediately upon start up. The load time to start weighing is optimized to be as short as possible. The scale goes into a standby power mode when inactive to wake up even faster. Auto-lock is optimized to be as fast as possible and can use a precision-based sliding window average to lock the scale.

To further minimize time-not-fishing for tournament fishers, the scale desirably has a color display allowing for the quick identification of culling indicators by color code, number, or both.

As explained above, using a culling tag set with matching color codes facilitates culling. The angler, can weigh a fish, use smart cull to identify the smallest fish instantly, and quickly identify the color coded cull tag of the fish to replace. In the event that a different color coded cull system is used, the scale includes user-adjustable cull indicator marks and colors. For example, the user could choose any RGB color for any of the 8 cull tag displays and also change the mark to be any number or letter of their preference. This user customization can also be controlled from the app (run by the smart device 108B), then sent to the scale. The app and the scale can synchronize the colors and markings so that they match on both platforms.

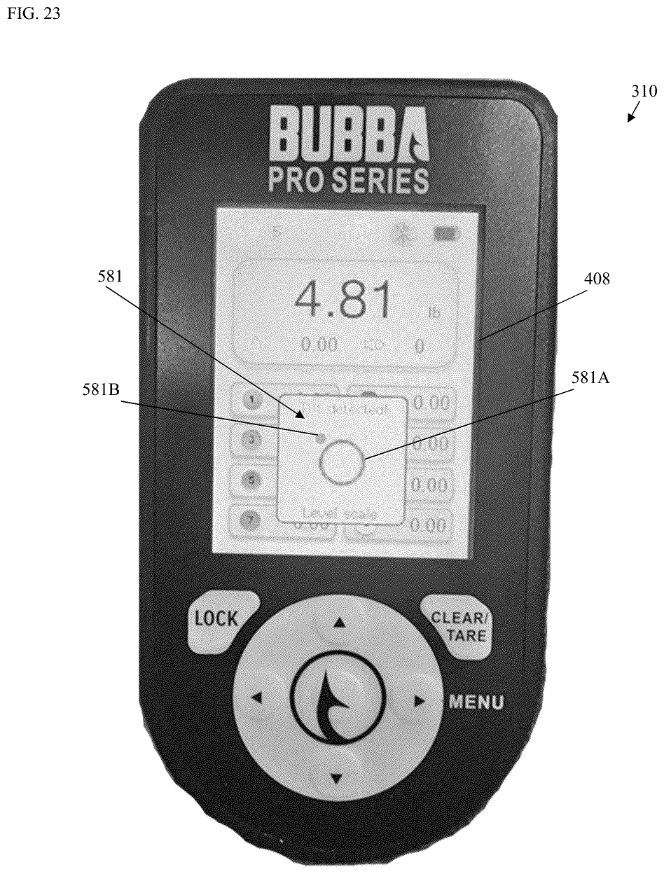

The accelerometer 441 can be used to further improve accuracy of the scale 310, to train users to hold it correctly, and to further improve auto-lock functionality. To train users, the accelerometer 441 measures the angle that the scale is being held and indicates on the display the correction the user needs to make to hold the scale perfectly vertical (i.e., the axis WA/HA (FIG. 3) vertical), maximizing the accuracy of the load-cell measurement. For example, referring to FIG. 23, if the user is trying to weigh a fish and the accelerometer 441 detects the scale is not vertical (e.g., more than 7.5 degrees off vertical), the display automatically begins to show a digital bubble level 581 (broadly, orientation guide) including a circle 581A (broadly, reference) and a dot 581B (broadly, orientation indicator). The user adjusts the orientation of the scale to move the dot (e.g., from outside the circle to inside the circle) to center the dot in the circle. The dot 581B moves essentially in real time responsive to feedback from the accelerometer to indicate to the user whether the scale is sufficiently upright to properly load the load cell. Accordingly, the user is trained and required to hold the scale in an orientations that leads to improved accuracy in weighing fish.

The accelerometer data can also be used to improve auto locking the weight. The controller runs an auto-lock algorithm in which it monitors the load cell data to identify when it is relatively stable (e.g., remained within a certain weight range (e.g., plus or minus 0.1 pound) for a preset time (e.g., three seconds)). When the stability threshold is met, the weight is automatically locked by the scale. As a prerequisite to locking the weight, the algorithm can require that the scale be correctly upright when the load cell data is identified as stable. For example, if the accelerometer indicates the axis WA/HA is less than 7.5 degrees off vertical (e.g., threshold orientation), the algorithm can be permitted to lock the weight based on the threshold load cell stability being met. Accordingly, the accelerometer 441 can be useful in facilitating accuracy of fish measurement by locking the weight as a function of the accelerometer data indicating the load cell is properly loaded. The accelerometer 441 can be used in the auto-lock algorithm to lock the scale only when the scale is stable and held correctly, along with the weight being stable, minimizing errors and preventing an auto-lock if a sudden motion (fish flop, boat rock) occurs. It will be appreciated that other types of motion or orientation sensors, instead of or in addition to an accelerometer, could be used without departing from the scope of the present disclosure.

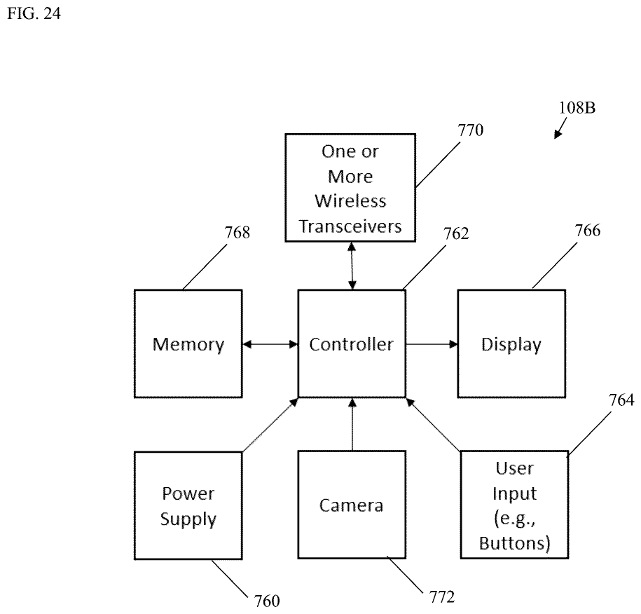

Referring to FIG. 24, the smart device 108B (e.g., smart phone, tablet, etc.) includes a power supply 760, such as a rechargeable battery, a controller 762 (e.g., processor), a user input 764 (e.g., buttons and/or touch screen), a display 766, a memory 768 (non-transitory tangible storage medium), and one or more wireless transceivers 770 (e.g., cellular, WiFi, Bluetooth, etc.). The controller 762 runs the smart scale application, receives user input, outputs to the display 766, sends and receives data via the wireless transceivers 770, and stores and recalls data from memory. It will be appreciated that the controller 762 of the smart device 108B may be used as or supplement the controller for the fish scale 310, and the tangible storage medium 768 of the smart device may serve as or supplement the tangible storage medium for the fish scale. In one example, the app running on the smart device 108B can mirror the user interface of the scale and permit advanced settings to be changed or updated. The smart device 310 can also include a camera 772 to take photographs and/or video of fish caught. The memory 768 stores non-volatile settings, weight and bag information. The wireless transceiver 770 can exchange settings, weight and bag information with connected fish scale. For example, the smart device 108B may include a short range wireless transceiver 770 (e.g., Bluetooth, WiFi, or the like) for connectivity to the fish scale and a long range wireless transceiver 770 (e.g., cellular network, satellite network, GPS, or the like) for connecting to a remote server (e.g., cloud server).

The scale 310 can be connected to the smart device 108B via Bluetooth connection. Once connected, the scale will sync its settings and mode data to the app. Mode data includes the current mode, any locked weight, the current bag total and bag weight (or weights for competition mode), any fish in the smart culling system and their culling tag. When a new fish is weighted and added to a bag, the scale will continue to sync data to the app. The syncing is bi-directional, meaning the scale is capable of making adjustments to any settings or mode data that the scale has. In this way, the smart culling system and settings can be co-managed by the app to provide more custom operating modes, rules, and prevent cheating.

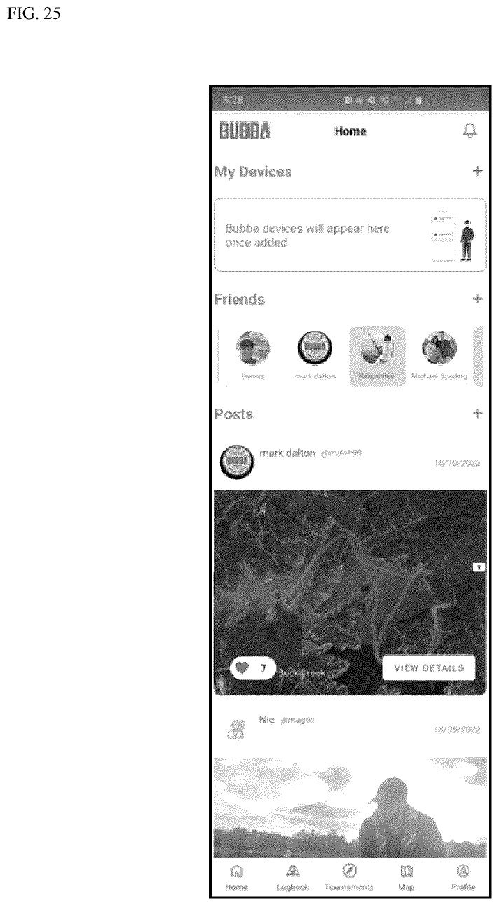

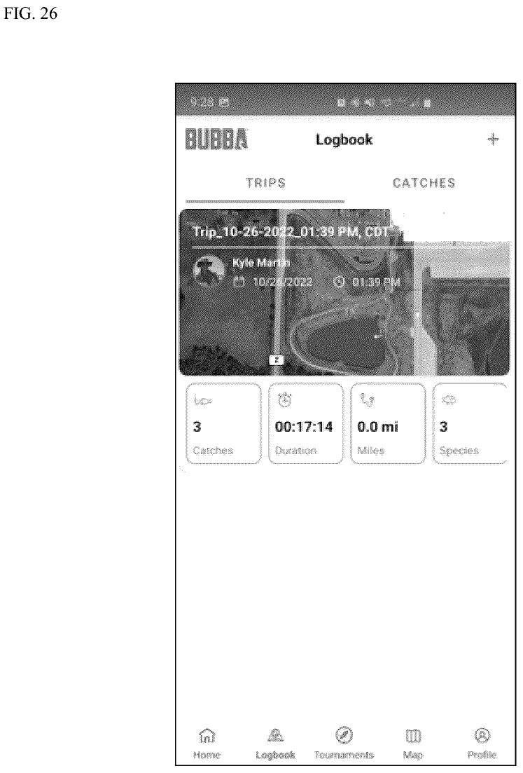

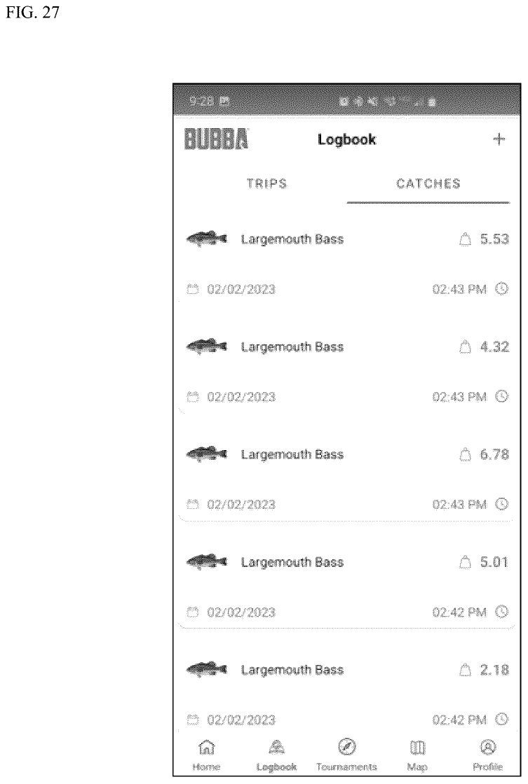

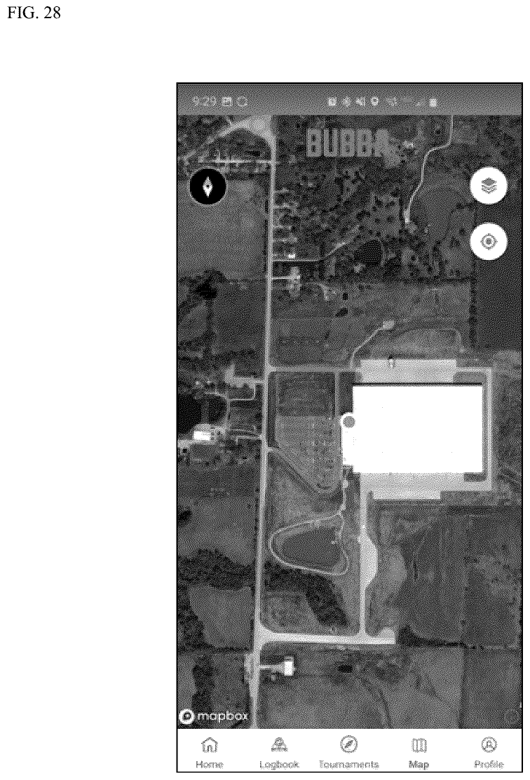

In other features of the smart device app, user data attached to a profile is used to log into the app. A user may be charged an access fee (e.g., monthly or yearly fee to use the app). Such access fee may “unlock” features of the scale, such as the Tournament mode or smart culling features. The smart fish scale can be paired to the app to send/sync new catches, mode data, and settings. Catches are pinned with the GPS location (via GPS transceiver of the scale and/or the smart device) and time when a new catch is reported by the scale. Catches can be manually entered as well. Trips can be started which log GPS breadcrumbs, pins, and time data. Tournaments allow many users (2 to 100s) to compete with each other. Catches can be posted to a feed and shared with others via the feed and/or text message or push to other app or feed. A user can add friends to their group to see posts of others in their own feed. In the app, users can keep track of their gear (rods, reels, bait, methods, etc) and attach this information to saved catches. Users can take photos of fish caught (e.g., using the smart device) and attach that to be linked with the catch data. The app can run an Al model to predict species from picture of the fish to tag the species of fish. Various screen shots of the app, including Home (showing connected devices and activity feed), Logbook Trips, Logbook Catches, and Map, are shown in FIGS. 25-28.

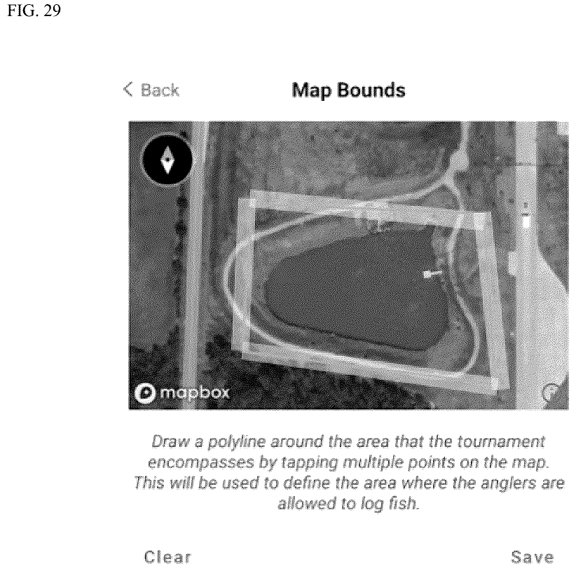

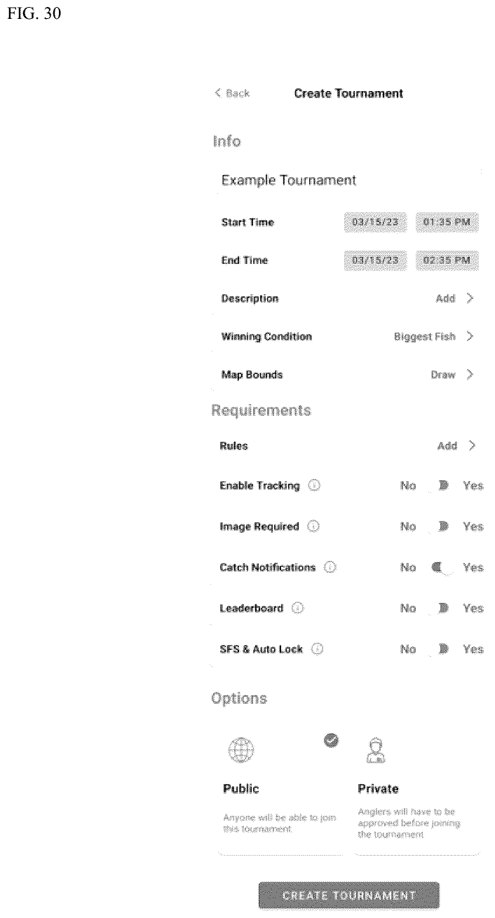

Referring to FIGS. 29 and 30, users can create and join tournaments in the app. A plurality of scale users can join the tournament to compile fishing data, such as in the Tournament mode. As shown in FIG. 30, when creating a tournament, a number of options can be controlled such as start time, end time, conditions, the area where fishing is to take place (e.g., establishing boundary as shown in FIG. 29), how many anglers, and the rules. The map bounds can be enforced by not allowing catches to be logged outside of the bounds, such as determined via GPS data from the scale or smart device. Users can be invited to a tournament with a link or they can search for the tournament by name in the app. Once the tournament starts, users activate the tournament and all fish logged in that time are added to their tournament bag. The rankings are determined and shared in the app. Tournaments can be managed externally through a CRUD API that allows the additional option of adding a roster. Anglers on the roster will receive an email notification to join the tournament or can be automatically enrolled. The settings that are selected in the tournament can be automatically synced to the scale to ensure all users have the same scale settings.

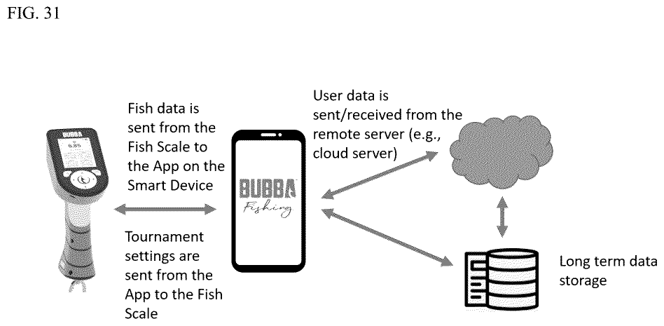

An example scale data communication system overview is shown in FIG. 31. Data is set from the fish scale to the app on the smart device. Tournament settings are sent from the app to the fish scale. User data is sent/received from the remote/cloud server to/from the smart device. Long term data storage may be accessed from the smart device and/or the cloud server.

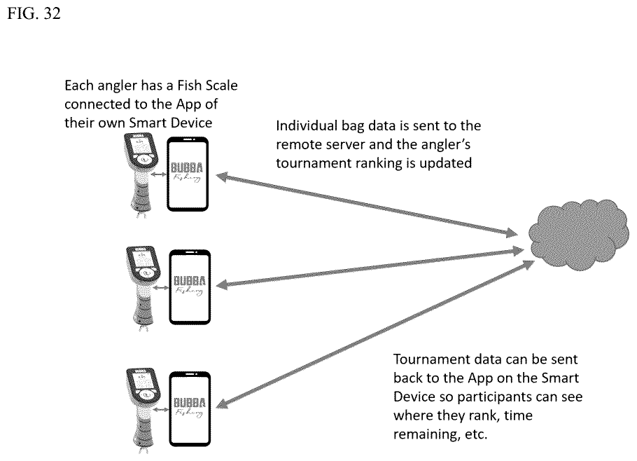

An example scale data communication system including multiple scales (e.g., for a tournament) is shown in FIG. 32. Each angler has a fish scale connected to the app of their own smart device. Individual bag data is sent to the remote server and the angler's tournament ranking is updated. Tournament data (e.g., updates, leaderboard, etc.) can be sent back to the app on the smart device so participants can see where they rank, time remaining, messages, etc.

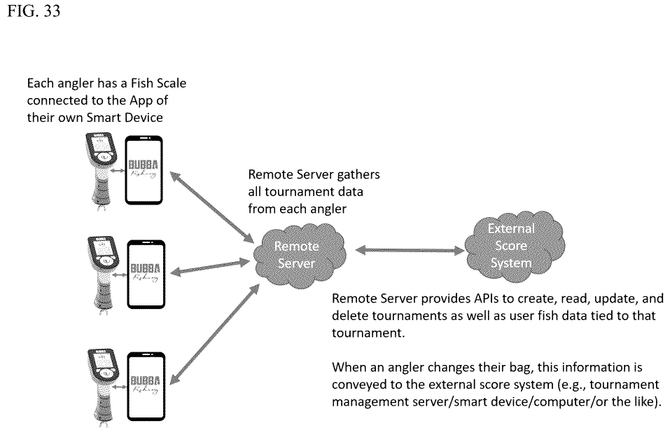

An example scale data communication system for tournaments with link to external score system is shown in FIG. 33. Each angler has a fish scale connected to the app of their own smart device. The remote server gathers all tournament data from each angler. The remote server is in communication with an external scoring system. The remote server provides APIs to create, read, update, and delete tournaments as well as user fish data tied to that tournament. When an angler changes their bag, this information is conveyed to the external score system (e.g., tournament management server/smart device/computer/or the like).

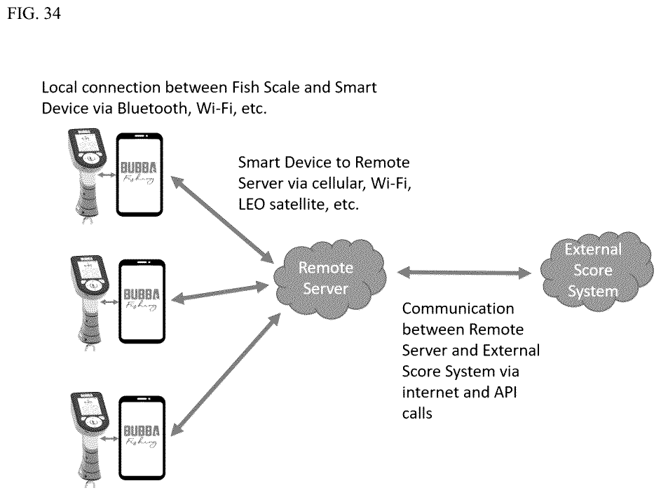

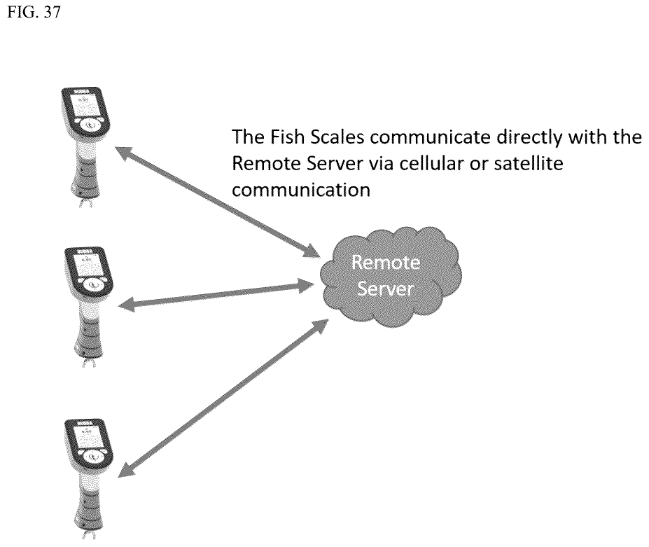

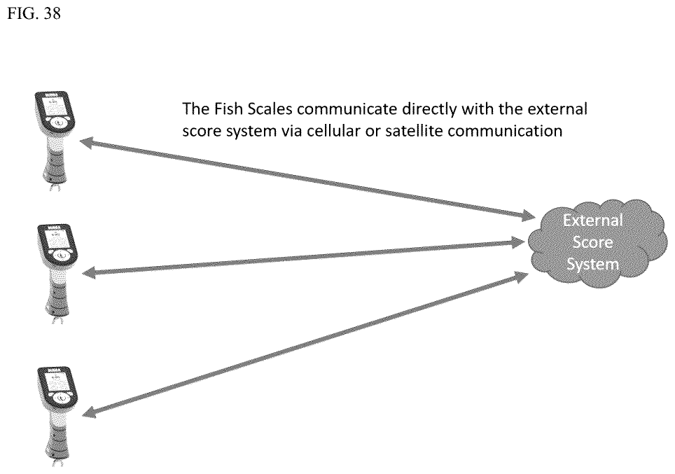

There are many ways that tournament data can be communicated and synchronized throughout the tournament. The ultimate goal of the system is to communicate data from the scale to the remote server or external score system. There are several topologies that can meet this goal, examples of which are shown in FIGS. 34-38.

In a first example, shown in FIG. 34, there is a local connection between the fish scale and smart device via Bluetooth, WiFi, etc. The smart device is connected to the remote server via cellular, WiFi, LEO satellite, etc. The remote server communicates with the external score system via internet and API calls. In an example operation, fish scales send data (e.g., weight) to respective smart devices. The smart devices send data (e.g., weight, user name, etc.) to the remote server. The remoter server sends data to an external score system. The external score system compiles/updates a leaderboard and sends the leaderboard (e.g., leaderboard data) back to the remote server. The remote server sends the leaderboard to the smart devices. The smart devices display the leaderboard to each user.

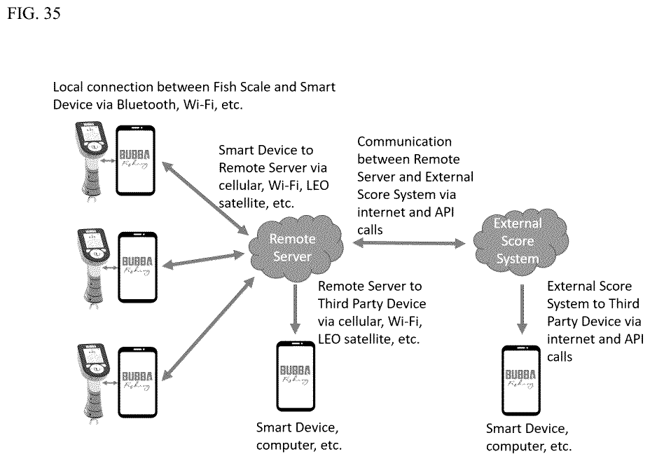

In a second example, shown in FIG. 35, there is a local connection between the fish scales and the respective smart devices via Bluetooth, WiFi, etc. The smart devices are connected to the remote server via cellular, WiFi, LEO satellite, etc. The remote server is connected to third party smart devices via cellular, WiFi, LEO satellite, etc. The remote server is in communication with the external score system via internet and API calls. The external score system is connected to third party smart devices via internet and API calls. In an example operation fish scales send data (e.g., weight) to the respective smart devices. The smart devices send data (e.g., weight, user name, etc.) to the remote server. The remoter server sends data to the external score system. The external score system compiles/updates a leaderboard. The leaderboard is sent to third party devices (e.g., smartphones of tournament spectators). Optionally, an external score system sends the leaderboard to the third party devices. Optionally, the external score system sends the leaderboard to the remote server, and the remote server then sends the leaderboard to the third party devices.

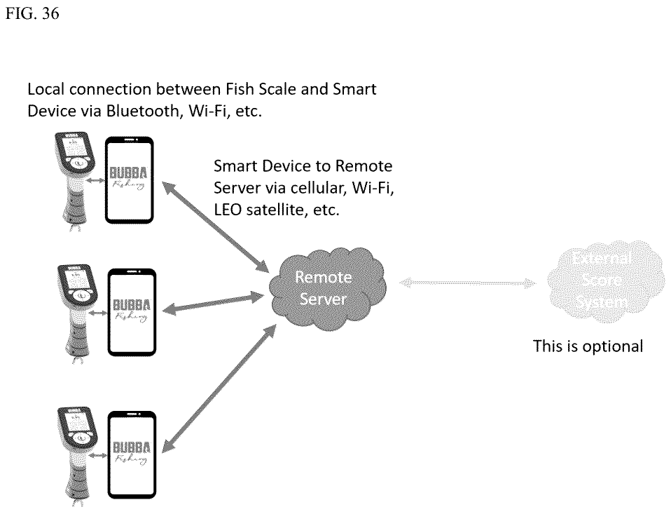

Other example systems are shown in FIGS. 36-38.

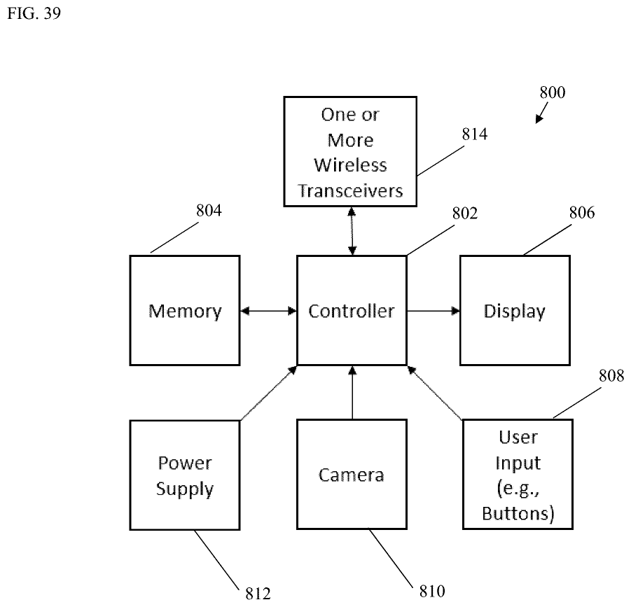

In another aspect of the present disclosure, a “heads up display” 800 can be used to provide additional access to information of the system. The purpose of the system is to aid anglers in effective tournament fishing by minimizing the time they spend not fishing. The system may include the dash mountable head unit or heads up display 800 (useable with or in place of another smart device) that could present the bag and tournament information in a convenient location to be read without needing access to the scale. An example of such a display unit 800 is shown in FIG. 39. The heads up display 800 includes a controller 802, non-transitory tangible storage medium 804, a user interface including a display 806 and a user input 808, a camera 810, a power supply 812 (e.g., battery), and one or more wireless transceivers 814 (e.g., such as those described above). The dash mountable display could be a smart device (e.g., tablet) or could mirror information shown on the scale and/or the app or take the place of the smart device and app. For example, if the dash mountable display is mounted to the dash console of the boat, the angler can review bag information while motoring the boat from one fishing spot to the next. Alternatively, the display could be mounted in other locations such as above the live well to optimize culling and live well management. Alternatively, the display information could be communicated to another instrument or device such as a fish finder or GPS already existing on the boat.

Regarding tournament APIs, the fish scale, app, and tournaments (cloud data) could benefit from additional API (application programming interface) and SDKs (Software Development Kits). For example, an API could be made available that allows a third party to change the settings of the scale and manage the bag and logged catches of the scale remotely via the smart scale app. This could be used to create new tournament rules and more closely manage the tournament from a third party system (e.g. other score systems). Another application of shared API/SDK would be to allow third party integration of the scale with other systems, such as a fish finder or GPS, or to allow third party app integration.

The fish scale and app can support tap-to-connect functionality. When the fish scale is touched (or in very close proximity) to the smart device, the app can automatically pair via Bluetooth (or other wireless connection) to the fish scale.

Optionally, the scale can be configured to have a stand-by mode that allows the fish scale to “wake up” (turn on the screen) when it is picked up or shaken (e.g., identified by accelerometer data). Thus the user would not need to press a button to turn on the scale.

The display of the fish scale can have different visual modes which can be selected by the user. Accessibility mode could remove screen color, use high contrast, and larger fonts to make the information easier to read. Dark mode could invert from a light background with dark text and icons to a dark background with light text and icons to be easier to read for night fishing. Themes could allow the user to pick colors that suit their taste or mood or some event or holiday.

The fish scale and cull set could use RFID technology to allow the fish scale to identify the cull indicator by tapping it to the device. For example, the fish scale could include an RFID reader, and an RFID chip could be provided in the float (e.g., foam ball) or otherwise on the cull tag. Upon weighing a fish, the user would tap the RFID cull tag (e.g., float or ball) to the fish scale to automatically log that catch on the cull tag.

Rather than using a smart device, the system could include a hub or gateway (e.g., the heads up display discussed above). The fish scale would connect to the hub or gateway to reach the remote server. Communication between the fish scale and gateway could be Bluetooth, Wi-Fi, Zigbee, some proprietary protocol, or another communication type. Communication from the gateway would go to cellular, satellite, etc. and/or an on-site tournament management system.

The fish scale could use the microphone 415 to enable voice control. For example, the angler could say the command “lock” to lock the fish scale. As another example, the angler could say the number of the cull tag to add the fish to the bag. This would save time and potential errors in using the button interface, especially with wet or slimy hands. The fish scale could also have a speaker (broadly, user output, including the display) to annunciate prompts and data. The fish scale, after the weight is locked, could state the weight for clarity. These features could also be provided with assistance of the mobile app and the smart device.

The case that holds the fish scale can contain its own power input or battery. When the fish scale is stored in the case, it is charged to keep the battery of the fish scale full for use. Alternatively, the fish scale has a charging port that can be plugged in to keep the fish scale charged without changing batteries. Alternatively, the fish scale has wireless charging capability.

Pro anglers sign up for a program to provide their catch data available to subscribers which pay a fee to receive this data. Subscribers may pay a one-time fee or a monthly or yearly subscription or some other payment schedule.

The software on the fish scale is updateable wirelessly. The software can be updated via the Bluetooth or Wi-Fi interface. The software can be updated by the connected app.

Images of fished logged in the app will go through an AI image recognition model which attempts to identify the species of the fish. By further improving the AI model, object and feature detection can be used to identify unique features of the specific fish. This information could be indexed as a sort of “fingerprint” (unique pattern specific to that fish). The model could then compare the fingerprint of newly logged fish to the fingerprints of previously indexed fish to determine how similar a fish is to one that was previously caught and give a probability that it is the same fish. In a catch and release scenario on a body of water, this information could be used to track individual fish movement, life, and growth (weight, size) in an area.

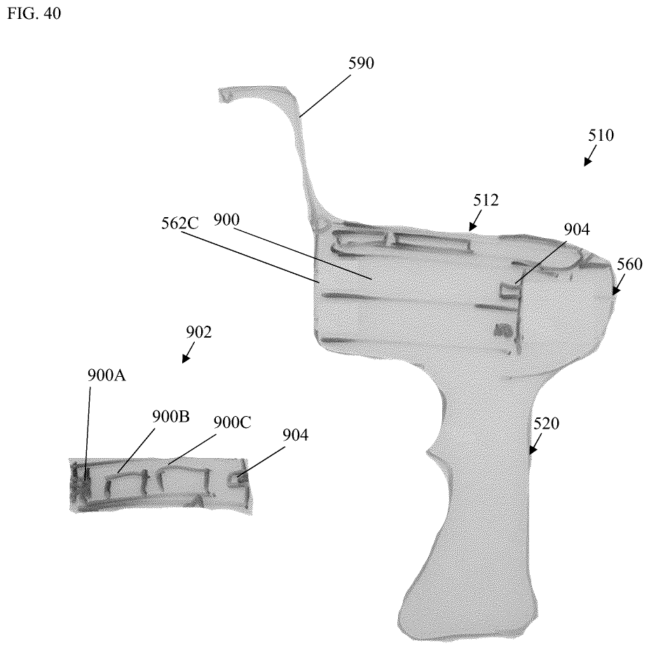

Another embodiment of a scale according to the present disclosure is shown schematically in FIG. 40 and indicated generally by 510. The scale is similar to the scale 10 and like features are indicated by like reference numbers, plus 500. For example, the scale includes a housing 512, a handle 520, and a head 560. The scale 510 may have essentially the same construction as the scale 10 except to the extent differences are noted hereafter.

In this embodiment, the scale includes a waterproof communications expansion bay 900 positioned above the battery compartment and below the process PCA with display, buttons, and Bluetooth module. The compartment door 590 (broadly, cover) is sized and shaped to cover the area of the mouth 562C providing access to the battery compartment and the expansion bay. To add additional communication capabilities to the fish scale (such as satellite) a communication expansion module 902 is inserted and secured into the expansion bay. The expansion bay 900 includes a bay connector 904. The expansion bay is sized and shaped to receive the communications module including a shared satellite transceiver 900A, LEO satellite transceiver 900B, and GPS transceiver 900C. The communications module 900 includes a module connector 900D configured to connect with the bay connector 904 when the module is received in the bay. The software on the fish scale can detect the expansion and automatically change its operation to support the new mode. The expansion could be satellite, but it could also be cellular, LoRa, or some other wireless technology. This module could also add other, non-communication hardware capabilities to the device or be used as an additional power source. The location of the expansion could be internal to the Fish Scale (a bay) but it could also be in a different location, or just plug into the scale, or communicate with the fish scale wirelessly.

In view of the above, it will be appreciated that the present disclosure relates to systems and methods for operating a fishing tournament. The system includes a fish scale for weighing each fish and storing the weight of each fish. The fish scale communicates (e.g., pairs) with a smart device (such as a smart phone). The smart device can run an application allowing a user or fisherman to interact with the fish scale. The smart device acts as a secondary control for the fish scale. The smart device can display the data stored and/or collected by the fish scale. The smart device can receive user input and send corresponding signals to the fish scale, such as to alter settings, delete data, change modes, etc. The smart device can also send the data collected/stored by the fish scale to server (e.g., tournament server) hosting the tournament. This can be done wirelessly, such as over a cellular network, satellite network, or any other wireless system. The smart device can also receive data from the server, such as tournament updates, tournament settings, leaderboard, etc., to display to the user. In other embodiments, the scale sends the data directly to the server.

It will be apparent that modifications and variations are possible without departing from the scope of the invention defined in the appended claims. The dimensions and proportions described herein are by way of example without limitation. Other dimensions and proportions can be used without departing from the scope of the present disclosure.

As various changes could be made in the above constructions and methods without departing from the scope of the invention, it is intended that all matter contained in the above description and shown in the accompanying drawings shall be interpreted as illustrative and not in a limiting sense.

What is claimed is:

1. An electronic fish scale comprising:
a housing;
a load cell supported by the housing and configured to generate load cell data responsive to a fish supported by the load cell;
a user interface supported by the housing;
an accelerometer supported by the housing configured to generate accelerometer data;
a fish scale controller configured to receive the motion data, the fish scale controller being operable to determine a weight of the fish supported by the load cell; and
a non-transitory tangible storage medium coupled to the fish scale controller, the non-transitory tangible storage medium storing fish scale controller executable instructions configured to, when executed by the fish scale controller, determine the weight of the fish supported by the load cell as a function of the load cell data and the accelerometer data.

2. The electronic fish scale as set forth in claim 1, wherein the non-transitory tangible storage medium stores fish scale controller executable instructions to determine the weight of the fish based on the load cell data indicating a stability threshold is met and the accelerometer data indicating a threshold orientation is met.

3. An electronic fish scale comprising:
a housing;
a load cell supported by the housing and configured to generate load cell data responsive to a fish supported by the load cell;
a user interface supported by the housing, the user interface including a display;
an orientation sensor supported by the housing configured to generate orientation data associated with the load cell;
a fish scale controller configured to receive the orientation data, the fish scale controller being operable to determine a weight of the fish supported by the load cell; and
a non-transitory tangible storage medium coupled to the fish scale controller, the non-transitory tangible storage medium storing fish scale controller executable instructions configured to, when executed by the fish scale controller, implement an orientation guide on the display to guide a user to properly orient the load cell for correct orientation of the load cell to correctly generate load cell data with the load cell.

4. The electronic fish scale as set forth in claim 3, wherein the orientation guide comprises an orientation indicator and a reference, a location of the orientation indicator with respect to the reference indicating an orientation of the load cell.

5. The electronic fish scale as set forth in claim 3, wherein the orientation guide comprises an electronic bubble level.

6. The electronic fish scale as set forth in claim 3, wherein the non-transitory tangible storage medium includes fish scale controller instructions to implement the orientation guide if the orientation sensor indicates the orientation of the load cell is outside a threshold orientation range.
